(19) United States
(12) Patent Application Publication
(10) Pub. No.: US 2021/0208599 A1
(43) Pub. Date: Jul. 8, 2021

(54) Control Device and Method for Automated Movement of a Motor Vehicle

(71) Applicant: Daimler AG, Stuttgart (DE)

(72) Inventor: Lissy LANGER, Boeblingen (DE)

(73) Assignee: Daimler AG, Stuttgart (DE)

(21) Appl. No.: 15/999,480

(22) PCT Filed: Feb. 15, 2017
(86) PCT No.: PCT/EP2017/000212

§ 371 Date: Aug. 17, 2018

(30) Foreign Application Priority Data
Feb. 17, 2016 (DE) 102016001814.3

(51) Int. Cl. G05D 1/02; G05D 1/00

(52) U.S. Cl. CPC G05D 1/0225; G05D 1/0246; G05D 2201/0213; G05D 1/0257; G05D 1/0055; G05D 1/0278

(57) ABSTRACT

A control device for automated movement of a motor vehicle includes a controller for automated actuation of control apparatuses in the vehicle for longitudinal and transverse control of the motor vehicle from a predeterminable starting position to a predeterminable target position. The control device further includes a navigation device for navigating the motor vehicle from the starting position to the target position.

### BACKGROUND AND SUMMARY OF THE INVENTION

The invention relates to a control device for automated movement of a motor vehicle. Furthermore, the invention relates to a method for automated movement of a motor vehicle.

Ready-assembled motor vehicles are usually manually driven out of the relevant assembly facilities to the corresponding handover parking spaces and then on to corresponding loading parking spaces, for example for loading onto a train or truck or customer center shipping. Subsequently, the employees who drove the motor vehicles to the corresponding locations are transported back to a starting point by a means of transport.

DE 10 2012 002 823 A1 discloses a generic control device for automated movement of a motor vehicle. The control device comprises a controller for automated actuation of control apparatuses in the vehicle for longitudinal and transverse control of the motor vehicle from a predeterminable starting position to a predeterminable target position.

An object of the present invention is to provide a control device and a method for automated movement of a motor vehicle, by means of which device and method reliable and safe automated vehicle transport is possible.

The control device according to the invention for automated movement of a motor vehicle comprises a controller for automated actuation of control apparatuses in the vehicle for longitudinal and transverse control of the motor vehicle from a predeterminable starting position to a predeterminable target position. According to the invention, the control device comprises a navigation device for navigating the motor vehicle from the starting position to the target position.

The control device according to the invention is used in particular for automated movement and thus transportation of motor vehicles during production. This may take place at the production site, in particular during end-of-line operation, but also outside the production site, for example between production facilities and loading parking spaces or other destinations within the factory premises. The control device is in this case preferably a control device located outside the vehicle that can be coupled to the motor vehicle as required and in-turn decoupled therefrom. In contrast to autonomous driving of a vehicle in road traffic, in which exclusively vehicle-internal controllers are used to move the vehicle, in this case vehicle-external control devices are preferably used. By means of the control device according to the invention, it is possible, for example, for ready-assembled motor vehicles to be driven autonomously out of an assembly facility to corresponding loading parking spaces. The navigation device according to the invention of the control device contributes to the motor vehicle being navigable in a particularly efficient manner from the starting position to the target position. By means of the control device according to the invention, it is therefore possible to significantly cut back on the use of workers for manually moving motor vehicles, such that relevant employees can focus their activities on other areas, as a result of which savings can be made on the workforce. In addition, the automated movability of motor vehicles reduces the risk of damage to the motor vehicles, it also being possible in particular to save on protective films inside the motor vehicles, since the motor vehicles are moved automatically, and therefore without workers having to sit inside the motor vehicles.

In an advantageous embodiment of the invention, the control device comprises a safety device for recognizing objects and/or monitoring the motor vehicle at given moments. Preferably, the safety device comprises a radar-based and/or camera-based detection device for recognizing objects. In other words, the control device is preferably equipped with safety technology, in order to be able to recognize and avoid people and other obstacles during automated movement of the motor vehicle. The risk of collisions and accidents can be significantly reduced as a result.

According to another advantageous embodiment of the invention, the navigation device comprises real-time kinematic technology. Real-time kinematic technology is usually also referred to as real-time kinematics and abbreviated to RTK. Real-time kinematics relates to a measurement method based on a global satellite navigation system, for example GPS, in which method highly accurate position results are obtained in real time for a mobile receiver, in the present case the navigation device used in the motor vehicle, in relation to a reference station. As a result, navigation by means of the control device of the relevant motor vehicle that is accurate to the nearest centimeter is possible. In particular in confined spaces, the control device can therefore navigate the motor vehicle in a particularly precise manner from the starting position to the target position.

According to another advantageous embodiment of the invention, the navigation device comprises at least one component, in particular a transmitter, for locating the motor vehicle in a building. In other words, the navigation device comprises part of an indoor locating system, and therefore the relevant motor vehicle can be reliably and precisely navigated by means of the control device inside buildings as well.

In another advantageous embodiment of the invention, the control device can be releasably coupled to the motor vehicle, in particular to an interface in the vehicle for on-board diagnosis of the motor vehicle. As a result, data can be exchanged with the corresponding control apparatuses of the motor vehicle in a particularly simple manner. For example, corresponding actual values for the individual control apparatuses can be retrieved via a CAN bus and, in turn, corresponding target values can be fed in by the control device via the CAN bus.

In the method according to the invention for automated movement of a motor vehicle, the motor vehicle is coupled to the control device according to the invention or an advantageous embodiment of the control device according to the invention at a predetermined starting position, and a target position and a route for reaching the target position are provided, and subsequently the motor vehicle is automatically controlled along the route from the starting position to the target position by means of the control device. Advantageous embodiments of the control device according to the invention are in this case to be regarded as advantageous embodiments of the method according to the invention, the control device in particular comprising means for carrying out the method steps.

According to an advantageous embodiment of the method according to the invention, after reaching the target position, the control device is decoupled from the motor vehicle and transported to the starting position by means of a tugger train. It is therefore not necessary to use workers for transportation back from the target position to the starting position, and therefore savings can be made on the corresponding workforce.

Further advantages, features, and details of the invention can be found in the following description of a preferred embodiment and with reference to the drawings. The features and combinations of features stated above in the description as well as the features and combinations of features stated below in the description of the Figures and/or shown in the Figures alone can be used not only in the specified combination in each case, but also in other combinations or in isolation without departing from the scope of the invention.

### BRIEF DESCRIPTION OF THE DRAWINGS

FIG. 1 is a schematic representation of a motor vehicle, which comprises a plurality of control apparatuses for longitudinal and transverse control of the motor vehicle, a control device for automated movement of the motor vehicle being coupled to an interface in the vehicle used for on-board diagnosis of the motor vehicle;

FIG. 2 is a schematic representation of an assembly facility and various loading stations and intermediate storage; and

FIG. 3 is a schematic representation of method steps for automated transportation and loading of the motor vehicle.

### DETAILED DESCRIPTION OF THE DRAWINGS

Identical or functionally identical elements are provided with the same reference signs in the Figures.

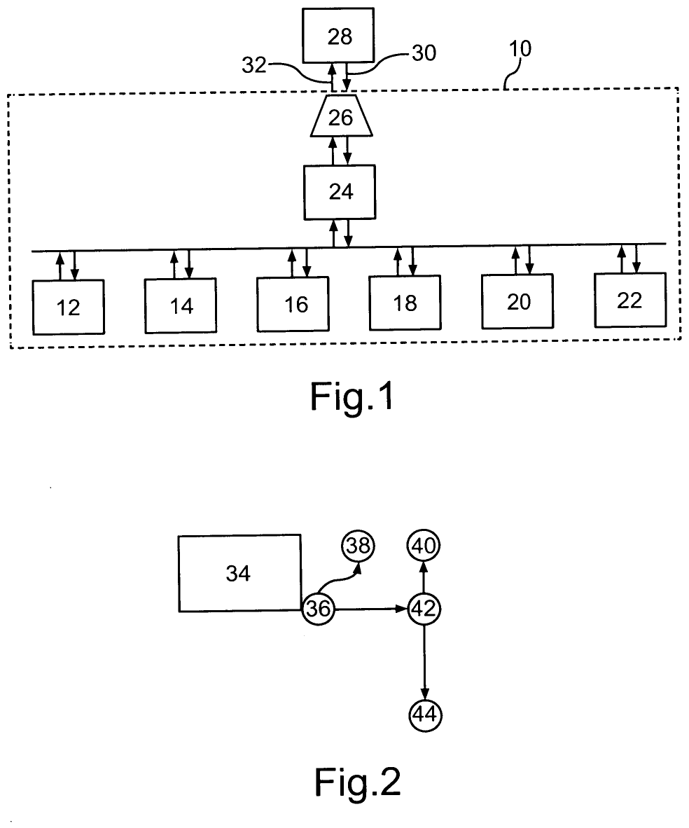

A motor vehicle 10 is schematically represented in FIG. 1. The motor vehicle 10 comprises at least one control apparatus 12 for a driver assistance system of the motor vehicle 10, a control apparatus 14 of a driving dynamics control system of the motor vehicle 10, a control apparatus 16 of an instrument cluster, a control apparatus 18 of an electrical steering system, a control apparatus 20 of an automatic transmission, and an engine control apparatus 22. Furthermore, the motor vehicle 10 comprises an ignition system 24 and an interface 26 for on-board diagnosis of the motor vehicle 10. The control apparatuses 12 to 22 are used for longitudinal and transverse control of the motor vehicle 10. The control apparatuses 12 to 22, the ignition system 24, and the interface 26 together form an on-board system (not further indicated) for automated movement or driving of the motor vehicle 10.

The controller, as already described in DE 10 2012 002 823 A1, is designed to activate ignition of the motor vehicle 10 and also to deactivate the same once the corresponding target position has been reached. The relevant motor vehicle 10 can therefore be started and deactivated again in an automated manner by means of the control device. Intervention on the part of workers for starting and deactivating the motor vehicle 10 can therefore be dispensed with. The control device must simply be coupled to the motor vehicle 10 such that ignition of the motor vehicle 10 can be activated and deactivated automatically.

Furthermore, the controller is designed to control at least one of the above-described control apparatuses 12, 14, 16, 18, 20, and 22 of the motor vehicle 10.

Therefore, the controller is designed to automatically actuate all control apparatuses of the motor vehicle 10 provided for longitudinal and transverse control of the motor vehicle 10, such that the relevant motor vehicle 10 can be moved from the starting position to the target position without human intervention.

A control device 28 is coupled to the interface 26 for on-board diagnosis of the motor vehicle 10, which device is used for automated movement of the motor vehicle 10. The control device 28 comprises a controller (not further indicated) which is designed to actuate the individual control apparatuses 12 to 22 of the motor vehicle 10 for automated longitudinal and transverse control of the motor vehicle 10 from a predeterminable starting position to a predeterminable target position. The controller can in this case specify target values 30 for the individual control apparatuses 12 to 22 and in-turn retrieve corresponding actual values 32 of the individual control apparatuses 12 to 22 via the interface 26. The control device 28 is designed to automatically activate and deactivate the ignition system 24 of the motor vehicle 10.

Moreover, the control device 28 comprises a navigation device (not shown here) for navigating the motor vehicle 10. Preferably, the navigation device in this case comprises real-time kinematic technology, which is also referred to as real-time kinematics, or RTK for short. As a result, the navigation device can receive data from a global satellite navigation system, for example via GPS, and compare the data with one or more reference stations in real time, as a result of which highly precise navigation of the motor vehicle 10, in particular to the nearest centimeter, is possible.

In addition, the navigation device (not further indicated) comprises at least one component, preferably a transmitter, for locating of the motor vehicle 10 in buildings. In other words, the navigation device is therefore designed to communicate with an indoor locating system such that the motor vehicle 10 can be navigated reliably inside buildings as well, even if no satellite signals can be received.

Moreover, the control device 28 comprises a safety device (also not further indicated) for recognizing objects and monitoring at given moments in time. The safety device can recognize people and obstacles in a radar-based and/or camera-based manner, such that the motor vehicle 10 can be automatically moved in a collision-free manner by means of the control device 28 from a predeterminable starting position to a predeterminable target position. The control device 28 is used in particular to move the motor vehicle 10 and other motor vehicles along in the production process, in particular during end-of-line operation, in an automated manner by means of corresponding control interventions.

FIG. 2 is a schematic representation of an assembly facility 34 for the motor vehicle 10. As soon as the motor vehicle 10 has been completed in the assembly facility 34, the vehicle is at a starting position 36 from which it is transported either to a train-loading station 38, a customer center 40, or to corresponding truck-loading stations 42, 44. Depending on the task at hand, the corresponding motor vehicle 10 is moved in an automated manner by means of the control device 28 out of the starting position 36 subsequent to completion in the assembly facility 34 to one of the corresponding target positions 38, 40, 42, 44.

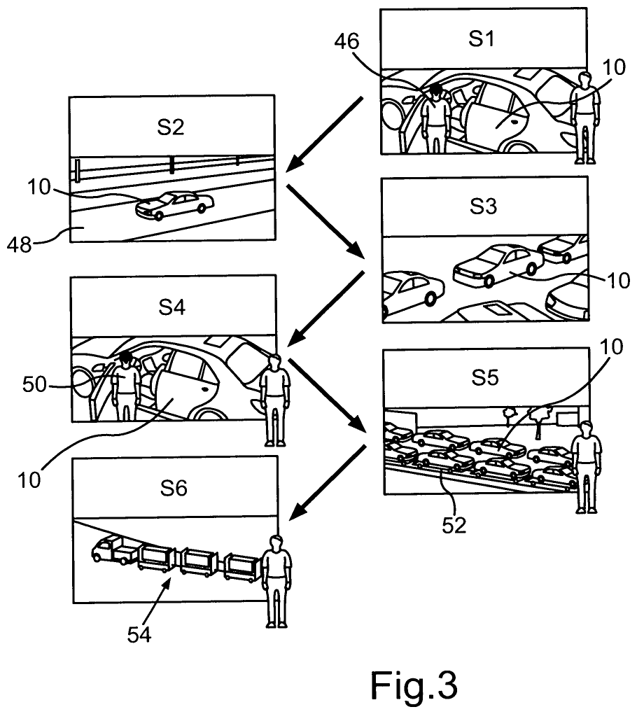

FIG. 3 shows a sequence of method steps S1 to S6 for automated movement of the motor vehicle 10. In method step S1, after completion, the motor vehicle 10 is still in the assembly facility 34, i.e., in the starting position 36. Here, a worker 46 installs the control device 28 in the motor vehicle 10, and thus couples the control device 28 to the interface 26 for on-board diagnosis of the motor vehicle 10. The control device 28 functions in this case as a kind of drive computer which is inserted in the motor vehicle 10 at the end of the last production line during end-of-line operation and coupled to the motor vehicle.

After the control device 28 has been coupled to the motor vehicle 10, a corresponding parking space relative to one of the target positions 38, 40, 42, 44 and a trajectory for reaching the corresponding target position are downloaded. After startup of the motor vehicle 10 is enabled by the worker 46, the control device 28 starts the ignition system 24 and thus the motor vehicle 10. As a result, the motor vehicle 10 automatically starts up the engine thereof, engages a corresponding gear, and proceeds along the correspondingly specified trajectory in accordance with method step S2, inter alia along a road 48 of a factory premises, to one of the target positions 38, 40, 42, or 44.

In method step S3, the motor vehicle 10 automatically parks in a correspondingly provided parking space from one of the target positions 38 to 44 by means of a corresponding actuation action of the control device 28. In method step S4, another worker 50 in-turn removes the control device 28 from the motor vehicle 10. In method step S5, the worker 50 or another worker drives the motor vehicle 10 onto a means of transport 52, for example a trailer of a truck. In method step S6, the control device 28 decoupled from the motor vehicle 10 is moved by means of a tugger train 54 back to the starting position 36, i.e., to the assembly facility 34, such that the control device 28 can be inserted in the next ready-assembled motor vehicle such that the vehicle can in-turn be controlled in an automated manner by means of the control device 28 to one of the target positions 38 to 44.

By means of the control device 28, it is therefore possible to autonomously drive respective ready-assembled motor vehicles, immediately after passing through an assembly-finish region, automatically to the respective target positions 38 to 44. The control device 28 therefore makes possible driverless vehicle transportation in a vehicle factory.

1.-8. (canceled)

9. A control device for automated movement of a motor vehicle, comprising:
a controller, wherein automated movement of the motor vehicle from a starting position to a target position is controllable by the controller; and
a navigation device, wherein the motor vehicle is navigatable from the starting position to the target position by the navigation device.

10. The control device according to claim 9 further comprising a safety device, wherein an object is recognizable by the safety device and/or the motor vehicle is monitorable by the safety device.

11. The control device according to claim 10, wherein the safety device comprises a radar-based and/or a camera-based detection device.

12. The control device according to claim 9, wherein the navigation device comprises real-time kinematic technology.

13. The control device according to claim 9, wherein the navigation device comprises a component for locating the motor vehicle in a building.

14. The control device according to claim 13, wherein the component is a transmitter.

15. The control device according to claim 9, wherein the control device is releasably coupleable to the motor vehicle.

16. The control device according to claim 15, wherein the control device is releasably coupleable to an interface in the motor vehicle for on-board diagnosis of the motor vehicle.

17. A method for automated movement of a motor vehicle, comprising the steps of:
coupling the motor vehicle to the control device according to claim 9 at the starting position;
providing the target position and a route for reaching the target position; and
automatically controlling the motor vehicle along the route from the starting position to the target position by the control device.

18. The method according to claim 17 further comprising the steps of:
decoupling the control device from the motor vehicle after the motor vehicle reaches the target position; and
subsequent to the decoupling, transporting the control device to the starting position by a tugger train.

19. The method according to claim 17, wherein the starting position, the route, and the target position are located in a factory that assembles the motor vehicle.
